(19) United States
(12) Patent Application Publication
(10) Pub. No.: US 2009/0119444 A1
(43) Pub. Date: May 7, 2009

(54) MULTIPLE WRITE CYCLE MEMORY USING REDUNDANT ADDRESSING

(75) Inventor: Paul G. Davis, San Jose, CA (US)

Correspondence Address: THE MUELLER LAW OFFICE, P.C., 12951 Harwick Lane, San Diego, CA, 92130, US

(73) Assignee: ZeroG Wireless, Inc., Delaware Corporation, Sunnyvale, CA (US)

(21) Appl. No.: 11/933,801

(22) Filed: Nov. 1, 2007

(51) Int. Cl. G06F 12/02; G06F 11/10

(52) U.S. Cl. 711/103; 714/812; 711/E12.008; 714/E11.006

(57) ABSTRACT

The present invention produces a low-cost reliable non-volatile memory with multiple write cycles. The memory circuit trades full configurability for increased reliability and decreased cost by providing a limited number of write or rewrite cycles utilizing an indirectly accessible register set that writes data into fully configurable memory. The circuit is useful for both providing upgrade capability to electronic computational systems and data robustness to logic storage systems. Less configurable non-volatile memory (NVM) block 201 is utilized in tandem with directly accessible fully configurable memory block 207. Arbiter 206 implements the redundant addressing that enables the multiple write cycle NVM functionality. Each block of less configurable memory contains an address segment 203 and a data segment 204. Address segment 203 refers to a specific cell in directly accessible memory 209. When the data in directly accessible memory 209 needs to be refreshed arbiter 206 will cycle through the stack of less configurable memory. For each block in the stack, arbiter 206 will load data segment 204 into the cell in directly accessible memory block 207 that has a corresponding address to the address stored in address segment 203. Since arbiter 206 moves down the stack sequentially, blocks that have redundant addresses will effectively rewrite the data stored in a preceding block. The result is an inexpensive NVM with rewrite functionality.

### FIELD OF THE INVENTION

The invention relates generally to electronic computational systems, and more specifically to field upgrading computational systems and providing data robustness to logic storage systems.

### BACKGROUND OF THE INVENTION

After manufacture and deployment, electronic systems may suffer from obsolescence or errors in the system's manufacture and design. Memory blocks are especially susceptible to manufacturing errors as they are comprised of numerous repetitive cells that are subject to the conflicting requirements of being able to both change and maintain specific states with high reliability. Therefore, manufacturers of complex memory blocks rarely expected perfect yields and designers anticipate that memory cells may fail while the circuit is operating. There are many methods and circuits that tend to alleviate the effect of memory defects on an electronic system. A somewhat related field relates to errors and obsolescence in the firmware of a computational system. Methods to repair errors in defective memory locations can also be applied to provide configurability to stored operational code.

All computational systems require operational code in order to function. In addition, systems often require part specific data. An example of such data would be a serial identification number for circuits that need to be electronically registered to operate as part of a network. Another example is calibration data in sensor systems for tuning out inaccuracies due to variances in manufacturing. Operational code and part specific data need to be retained by a computational system when the power is removed so that the system can function properly when power is resupplied. This data is therefore stored in non-volatile memory (NVM) which is capable of retaining its state regardless of any external stimulus.

The most stable form of NVM in electronic circuits is called mask read only memory (ROM). Mask ROM is permanently fixed into the physical layers of the circuit. Although stable, this form of memory is non-configurable and cannot be part specific. Other forms of NVM such as electrically erasable and programmable read only memory (EEPROM) have a great advantage in configurability as they can be reprogrammed numerous times but are limiting due to their increased cost and decreased reliability. A compromise solution is the use of one time programmable (OTP) NVM such as electrically programmable read only memory (EPROM). OTP is usually much smaller and more reliable than memories with multiple write cycles and carries the benefit of being configurable after a part is manufactured. However, OTP can only be programmed once which is a limited improvement over mask ROM in terms of configurability. If a code in OTP is incorrectly programmed or made obsolete there is no difference from a system perspective between the cell containing such a code and a wholly dysfunctional memory cell. Therefore, techniques that repair defective memory blocks can also be applied to advantageously improve the configurability of operational code stored in OTP memory.

Memory defects can take several forms. The most common source of memory defects are caused by errors in the manufacturing process and degradation during the life of a memory element. A defective memory cell may suffer from failure to program wherein the memory will not retain the value that it receives. A defective memory cell may also suffer from unintentional programming. Unintentional programming occurs when a memory cell changes its state spontaneously without a programming signal being sent. This type of error is more difficult to detect since systems are designed to expect changes in a memory's state only upon the application of external stimulus.

Methods for improving the reliability of memory devices can be roughly grouped into two categories. Data integrity methods are meant to prevent corruption in memory from occurring in the first place and include selection of the type of memory to be used and protection circuits for controlling the operating conditions of the memory. Data robustness techniques are meant to allow a system to tolerate memory failures and continue to function. One technique involves the use of error correction codes (ECCs). ECCs are digital codes that are appended to functional data that will act to detect and possibly correct errors in the data as it is stored and transferred. An additional technique that applies data robustness is the use of data redundancy. Such techniques provide additional memory cells or store data in more than one location in case the primary memory fails. A final technique is to provide data correction in the system. Such techniques act to correct the data when it is read out of a defective location or allows the system to function without the corrected data until it can be repaired by a refresh or recalibration operation.

A common and effective approach for providing data robustness to a system is to combine both data redundancy and data correction methods. Such approaches can be referred to as redundancy rerouting techniques. An early example of such a method is described in U.S. Pat. No. 3,753,244 to Sumilas. This method has often been applied to large memory arrays where memory blocks are scanned for defective entries after manufacture. If defective entries are found they are marked and remapped to a redundant memory location. In computational systems the circuitry that implements this remapping is often referred to as the arbiter. When the system is operating and defective locations have been remapped, a request to store or retrieve data at the defective location will be intercepted by the remapped arbiter and the request will be routed to a redundant memory location. The remapping is commonly stored in NVM because the defective memory often needs to be replaced for the entire operational life of the system. Several methods for storing or triggering the remapping in NVM have been disclosed in patents. An example of such a method is provided in U.S. Pat. No. 6,208,568 to Zagar.

Much of the recent art in redundancy remapping techniques is directed towards providing remapping while the system is in its operational state. For example, U.S. Pat. No. 6,418,068 to Raynham allows for detecting and remapping defective memory cells in servers that are required to be continually operating. A similar approach that relates to field programming of a NVM is disclosed in U.S. Pat. No. 5,751,647 to O'Toole. The circuit in this patent makes repeated attempts to program an NVM cell and monitors the number of attempts. After a preset number of attempts fail, the circuit will implement the arbiter remapping automatically and the defective NVM location will be effectively replaced by a redundant location.

Most remapping techniques are relevant to random access memory (RAM) where individual memory cells are addressable individually. First in first out (FIFO) memory blocks are somewhat more conducive to remapping techniques. Individual word lines in a FIFO memory block are not individually addressed. Instead, the memory is accessed in a preset series where the word lines are cycled through by a shift register or some other means. Remapping can be accomplished by altering the cycle pattern rather than comparing and substituting addresses. An example of a remapping technique applied to a FIFO memory block is described in U.S. Pat. No. 5,968,190 to Knaack. The circuit applies test patterns to each word line in the memory stack and uses comparison circuitry to see if the word line is operative. If an error is detected by the comparison circuitry the word line is disabled. The shift register associated with the stack can interact with flag error signals and implement the remapping without affecting the rest of the circuit.

In U.S. Pat. No. 6,977,840 to Fournel, a redundancy remapping techniques is applied to a FIFO memory stack for the express purpose of providing a few times programmable (FTP) memory. A few times programmable memory is one that can be reprogrammed but has a limited number of write cycles. A redundancy remapping circuit can serve this purpose because the remapping acts as a write cycle that replaces the original memory with the redundant memory. An illustration of the general method is shown in FIG. 1. Memory 100 displays the condition FIFO stack 101 will be in prior to reprogramming. Top cell 103 contains the programmed value of the stack which is available for a read operation. The stack of redundant cells 104 has not yet been programmed and its contents are therefore labeled unprogrammed. The data in this stack is not meant to be read by the system. If the data in top cell 103 needs to be replaced or is defective, write cycle control 102 can perform a reprogramming operation. After write cycle control 102 has performed its operation the stack will be in the same state as memory 110. The value in top cell 103 will remain stored in memory since it cannot be deleted but it will no longer be accessed by the system. Instead, one of the redundant cells will be programmed with a new value in the same manner as new value cell 105. The number of redundant cells in remaining redundant cell stack 106 will be one less than in the pre-write redundant cell stack 104. The number of write cycles is only limited by the number of redundant memories that can serve as replacements of a prior memory block. The Fournel application specifically uses a FIFO memory block whose elementary units are OTP. Each memory element within the FIFO memory block contains a code that can be programmed with a value to assist the system in selecting the next memory element in the block to be selected.

Another related area of prior art is the use of indirect register sets. A common use of complementary memory units in an electronic computational system occurs when operational code stored in ROM is loaded into a RAM memory so that the operational code can be accessed more effectively by the system. Other purposes for moving code between memory locations include methods for the type of remapping discussed previously in relation to redundant rerouting. A patent that is related to this type of operation is U.S. Pat. No. 6,735,664 to Keller. This patent relates to manipulating or accessing data in indirect registers by controlling a routing system and directly accessible registers.

### SUMMARY OF INVENTION

In one embodiment of the present invention a multiple write cycle memory is disclosed for providing field upgrade capability and data robustness to an electronic system. The memory circuit has a first block of memory with multiple data locations coupled to an arbiter circuit. The memory circuit also comprises a second block of memory having multiple cells with individual cell addresses coupled to said arbiter circuit and a memory access circuit. The data locations each have a corresponding address segment that can be programmed with at least a portion of said cell addresses and a corresponding data segment that can be programmed with data. The data locations are programmed by external means. The arbiter of the memory circuit can load the data stored in the first block of memory into the multiple cells of the second block of memory in accordance with the value in the address segment.

In another embodiment of the present invention a method is disclosed for providing multiple write cycle capability and data robustness to an electronic system using minimally configurable memory. The method is comprised of several steps. The first step involves resetting a stack access apparatus of an arbiter circuit in response to a reset signal. The next steps are to increment the stack access apparatus and check the status of a data location in a first block of memory that is currently referenced by the stack access apparatus. If the currently referenced data location has been programmed the following step will be to write to a corresponding cell of a second block of memory with data from a data segment of the data location that has a cell address equivalent to the address segment of the data location. The steps from incrementing onward will be repeated at this point until it is determined in the checking step that the data location has not been programmed. If the location has not been programmed the next step will be to hold for a program command. Upon receipt of a program command the method will continue with programming a new address segment and a new data segment into the currently referenced data location in the first memory block. After programming the method will continue by returning to the step of checking the status of the currently referenced data location.

### BRIEF DESCRIPTION OF THE DRAWINGS

FIG. 1 is an illustration of a prior art FTP memory before and after reprogramming.

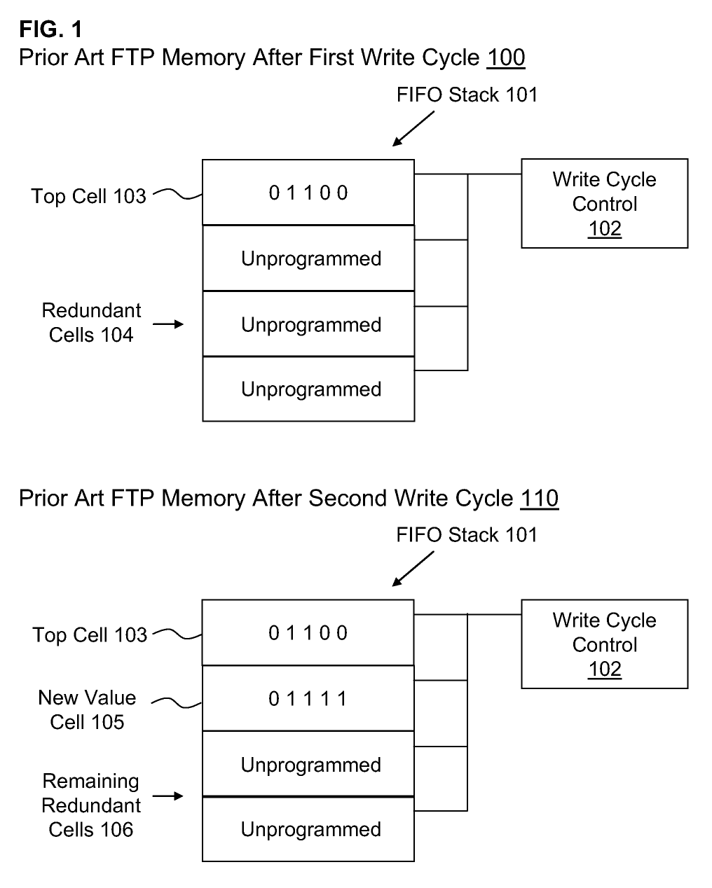

FIG. 2 is an illustration of an embodiment of the present invention using an external system for error checking.

FIG. 3 is an illustration of an embodiment of the present invention before and after a write cycle.

FIG. 4 is a block diagram of a method that is an embodiment of the present invention.

### DETAILED DESCRIPTION OF THE PREFERRED EMBODIMENTS

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the spirit and scope thereof. For instance, features illustrated or described as part of one embodiment may be used on another embodiment to yield a still further embodiment. Thus, it is intended that the present subject matter covers such modifications and variations as come within the scope of the appended claims and their equivalents.

The present invention utilizes redundant addressing to create a low cost configurable memory with minimal complexity. The memory has an efficient system for data robustness and configurability for field updates without the use of high cost reprogrammable memory cells. This is accomplished by trading full configurability for a limited number of write cycles so the invention is therefore most useful in applications where memory needs to be reprogrammed a limited number of times. For applications in which the number of required reprogram cycles is somewhat limited it is more cost efficient from a size and reliability perspective to use redundant OTP cells instead of one multiple programmable cell. In utilizing the present invention, a designer that can estimate the number of times a given portion of data will need to be upgraded and the number of times any given OTP cell will fail can design a cost effective NVM with a determined number of redundant OTP cells. In addition to providing decreased cost for certain limited write cycle applications, the circuit also provides for decreased complexity as compared to other FTP architectures. Decreased complexity is achieved as the redundant addressing scheme enables the use of a similar shift register and arbiter as would be used in a standard sequentially accessed memory.

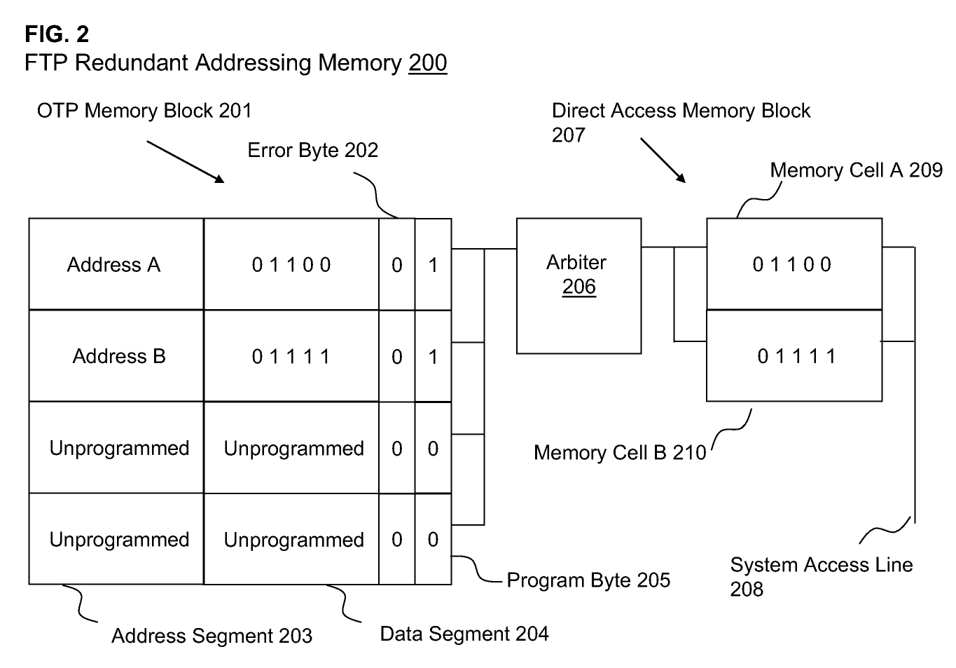

A basic embodiment of the redundant addressing FTP circuit is displayed in FIG. 2. FTP redundant addressing memory circuit 200 is comprised of OTP memory block 201, arbiter circuit 206, and directly accessible memory block 207. Directly accessible memory block 207 will most likely be some type of volatile random access memory (RAM). In FIG. 2 the directly accessible memory bank is illustrated by two cells. Memory cell with address A 209 and memory cell with address B 210 could be accompanied by any number of additional cells. The data stored in each data location of OTP memory block 201 contains an address segment 203, a data segment 204, an error byte 202, and a program byte 205. In FIG. 2, half of the data locations in OTP Memory Block 201 are unused and are labeled unprogrammed. The labels Address A and Address B in OTP memory block 201 are used to show that the address segment 203 of the top two data locations in OTP memory block 201 are programmed with the addresses of the memory cells in directly accessible memory block 207.

Memory cells 209 and 210 are directly accessible by the computational components of the system through system access line 208. Although system access line 208 is drawn as a single line any type of memory interface may be applied in its place. When the system starts up, arbiter circuit 206 will obtain the programmed data value in OTP memory block 201 and load the values into the addressed cells of directly accessible memory block 207. The address of memory cells such as 209 and 210 will not change as a result of this loading but the data contained within the cell will be altered. The resultant behavior of such a system allows data to be updated without the computational system being affected. The invention can therefore be applied without placing any requirements on the interface through system access line 208. Memory circuit 200 could possibly update the data while the computational system is performing its operations which would allow for online updates or bug repairs.

The FTP configurability of the system is afforded by unprogrammed data locations in OTP memory bank 201 when the device is manufactured. In one embodiment, every time the system is powered on or refreshed, arbiter circuit 206 will load values into the cells of direct access memory block 207. Direct access memory 207 could initially be loaded with data from mask ROM through arbiter 206. When configurability is required, the values in address segment 203 and data segment 204 of the first data location in OTP memory block 201 could then be programmed. Concurrently, program byte 205 of the programmed data location would need to be set high. Arbiter circuit 206 will scan down through the data locations in memory block 201 using a shift register. If arbiter circuit 206 detects a high program byte 205 in a data location of OTP memory block 201, it will load the contents of data segment 204 of the data location into direct access memory block 207. The particular address of the memory cell in 207 that will be written to is the address stored in the corresponding address segment 203. Arbiter circuit 206 will continue to scan down the list of OTP memory block 201 until it encounters a data location whose corresponding program byte 205 is low indicating that the cell has not been programmed. At such point the data in directly accessible memory block 207 will be fully updated with the most recent data and it will be unaffected by failed memory locations in OTP memory block 201.

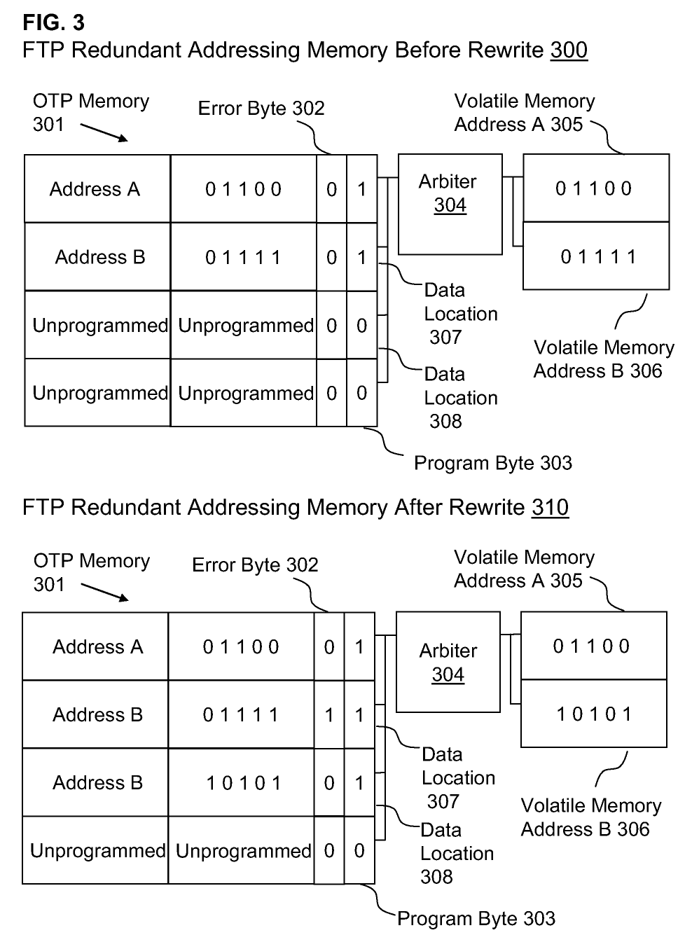

Directly accessible memory block 207 can be subsequently reconfigured as long as there are unprogrammed cells in OTP memory block 201 remaining. FIG. 3 illustrates the procedure that can be followed to implement a reconfiguration for field upgrades or a defective memory replacement. The figure illustrates the state of the circuit before a rewrite 300 and after a rewrite 310. In state 300, arbiter 304 has loaded volatile memory cell with address A 305 with the data from a data location in OTP memory 301 whose address segment is programmed with a value equal to Address A. Likewise, arbiter 304 has loaded volatile memory cell with address B 306 with the data from another data location 307 in OTP memory 301 whose address segment is programmed with a value equal to Address B. An inciting event such as an error in the data segment of OTP data location 307 caused by a reprogramming error or the obsolescence of the data segment of data location 307 will both require that the data in volatile memory cell with address B 306 be rewritten. Update circuitry will correspondingly program error byte 302 of data location 307 high. As a result, the shift register of arbiter 304 will skip word line 307 in any ensuing refresh operation. Additionally, update circuitry will program the address segment of data location 308 that was previously unprogrammed with address B and the data segment of data location 308 that was previously unprogrammed with the replacement data for volatile memory cell 306. Finally, update circuitry will program the program byte 303 of data location 308 high to indicate that the cell has been programmed. On an ensuing refresh cycle arbiter circuit 304 will load the data from the first data location of OTP memory 301 into the volatile memory segment with address A 305. Arbiter 304 will then skip data location 307 in response to its high programmed error byte 302 and load the data in the data segment of data location 308 into the volatile memory cell 306. In doing so the system will be updated or the error in data location 307 will be corrected at the minimal cost of a single additional OTP segment.

The arbiter required for this embodiment would require a lesser degree of complexity as compared to a typical FIFO arbiter. Since the addresses are programmed into the data locations the arbiter could be controlled directly by hardware using the address segment bits as inputs. The shift register for the stack would only need to be programmed to either skip or accept a given word line in the stack based on the state of the word line's program and error bits. Other than these two main requirements the shift register and arbiter would be the same as for a regular FIFO stack. In fact, the present invention could be applied without making any modifications to the arbiter and without using error bytes 302. For a slight decrease in speed the arbiter can simply rewrite the data stored at a redundantly referenced address. As compared to the Fournel implementation this circuit uses the limited configurability of an FTP memory in a more efficient way. In the Fournel circuit a stack of redundant locations needs to be reserved for every possible segment of code that may need to be updated or repaired. Each individual stack can only be applied to a single code. However, the present invention has a benefit in that the redundant memory location can be assigned to any of the replaceable segments individually. This gives an added degree of configurability in the system to allow for situations in which a particular memory block needs to be upgraded an unexpectedly large number of times.

In FIG. 2 the status of any particular data location is set by two bits. This embodiment will function properly but the reliability of such bits would have to be very high. Considering the fact that one of the applications of the invention is to correct for OTP cells that failed to programmed or suffered from unintentional reprogramming it is desirable to utilize a more robust method for indicating the cell's status. To this end, it is desirable to use error correction code segments as part of the data locations in the OTP memory block. In particular, error correction mechanisms such as single error correction, double error detection (SECDED) or double error correction, triple error detection (DECTED) could be applied. In one embodiment each addressable location in the OTP memory block could have 16 bits for data storage and 9 bits for an error correction syndrome (DECTED). The location would also have a 13 bit address, a 2 bit length code to indicate the length of the data segment, and a 1 bit invalid code. If such an error correction scheme is utilized the arbiter would have to be slightly more complex and have the ability to check the syndrome of each NVM location and provide error correction for faults in the data. Alternatively the error bit could be stored in a different type of memory that offered a higher degree of reliability than the other bits in the NVM. This would allow a designer to maintain low cost by using a majority of low reliability NVM but maintain reliable error correction.

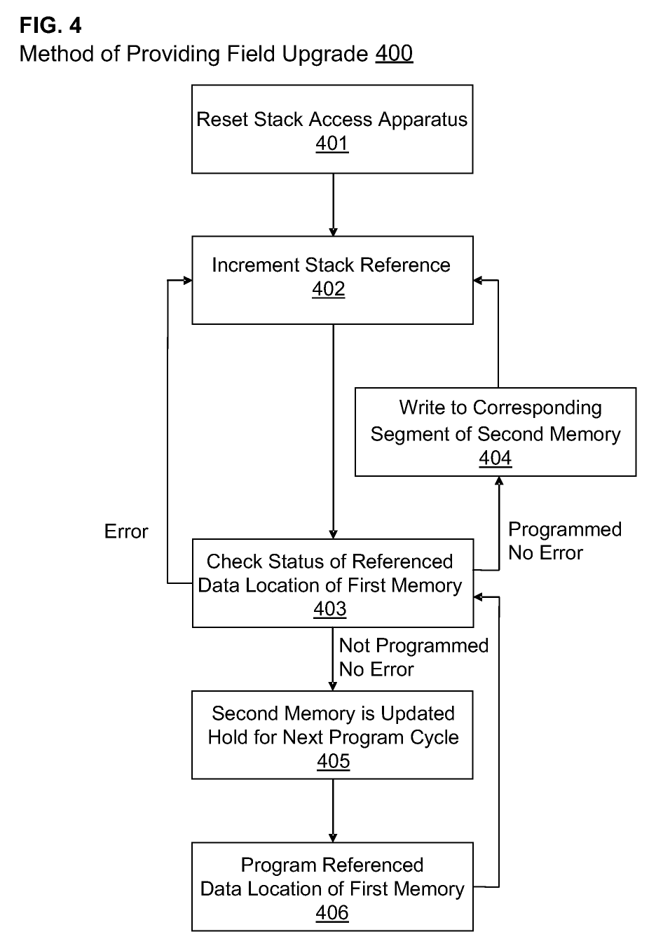

FIG. 4 is a flow diagram 400 of a method representing an embodiment of the present invention. The present embodiment is a redundancy rerouting technique that can be applied for field upgrades or for defective data location repair. In step 401 the arbiter cycle is reset. This first step could be taken at the receipt of an external signal. Most likely the external signal will be a reset signal sent when the circuit first powers on. If the directly accessible memory block has been implemented in volatile memory the directly accessible memory block will not have any data stored and will need to be updated.

After the arbiter is initialized it will be incremented to access the first data location of the redundant memory in step 402. The contents of the referenced data location will then be determined in step 403. If the location contains an error indicator the circuit will immediately return to step 402 and increment the arbiter cycle. If instead the referenced data location does not contain an error and has previously been programmed with data the arbiter will write to the corresponding location in the directly accessible memory block in step 404. The corresponding location will be that location that has an address which is equivalent to the address stored in the currently referenced data location of the redundant memory block. Finally, if the content determination step 403 finds that the currently referenced data location has not been programmed and also does not contain any errors the circuit will have found the end of the programmed data and it will hold for the next program cycle in step 405.

The memory's program cycle will begin when the circuit receives a program command. At such time the currently referenced unprogrammed data location in the redundant memory will be programmed in step 406 and the system will return to step 403 to check the contents of the most recently programmed cell. As long as the arbiter correctly determines the programmed or unprogrammed status of each data location the circuit will be able to determine that the data location it holds on in step 405 will be the next data location that should be programmed to. All previous cells in the stack will have been skipped because they contained errors or will have been written into corresponding data locations in the directly accessible memory block.

There are several variations of the described method that would provide utility in varying situations. For example, the error response branch from steps 403 to 402 could be eliminated. In such a method the erroneous code would be written into the directly accessible memory cells but it would be overwritten on a later cycle. This modification would trade the complexity of the arbiter for a slight decrease in the speed of the refresh cycle since defective data locations would still be written into the direct access memory instead of being skipped.

The current method could also be applied with any number of different types of error and program indicators. Error indicators could include a single bit, complex error combination codes, or a combination of the two. The method could also function utilizing a circuit designed to program the indicators using external logic. The method could also apply error detection circuitry that determined an error by monitoring the program bit rather than an error bit. Such circuitry would count the number of times the circuit looped from step 406 to step 403. If a certain number of loops was detected the circuit would be able to determine that the program bit of the specific data location was not functional and could proceed to step 402. Programming could also be determined by detecting a change in the data location from an original known state. For example, if the OTP memory bits were designed to be low before initial programming, the detection of a high bit would indicate that the circuit was programmed or contained an erroneous value.

It should also be noted that the updating could be applied in an online manner wherein the second memory is available to the computational system while being updated. Such an approach would only require a slight modification of method 400 which would involve an additional qualifier for the 403 to 404 path. After it is determined in step 403 that the referenced data location has been programmed and does not contain any errors, the circuit would have to wait until given permission to write to the second memory location in step 404. This would prevent an error in reading data from the directly accessible memory caused by a read and write operation being conducted at the same time.

As mentioned, one of the benefits of the present invention is the simplicity of the arbiter necessary for the circuit's implementation. However, the arbiter could be of a more complex form such as one that maps the address by applying an offset or conditional offset in order for the addresses to be mapped into a more complex addressing scheme. Although such a scheme is desirable and would add to the utility of the present invention, the method should not be applied in a manner such that the memory addressable by the arbiter orchestrates the remapping. For example, if a microprocessor is used to process the list, the program stack memory, the processor registers, and any registers that control the processor should not be in the map that list entries may modify.

Another type of mapping that could be used involves the use of addresses in the redundant memory that are smaller than the addresses in the directly accessible memory. This could be useful if applied in an application where the same piece of data needed to be applied to several locations in the directly accessible memory. The arbiter circuit would accomplish a remapping by writing the data contained in the redundant memory to any of the directly accessible memory cells that shared the same root address as the address stored in the redundant memory data locations. For example, if the address segment in the redundant memory data location contained an address segment ‘00’ and the addresses in the directly accessible memory were three bits then the data in the corresponding data segment would be written to addresses ‘001’ and ‘000’ in the directly accessible memory. In addition, the size of the redundant memory data segments do not have to match the size of the data segments in the directly accessible register. The invention could allow for a length code to be applied to each word line in the redundant memory. The length code could indicate the size of the code to be replaced. For example, if the location in the directly accessible memory was 8 bits and the redundant memory data segments were 12 bits, a length code indicating 8 bits should be selected that would instruct the arbiter to only select 8 bits from the redundant memory data segment to apply to the 8 bit directly accessible memory. The length code could then be modified in cases where the arbiter was connected to direct access memory blocks that had different cell sizes.

In the previous embodiments the redundant memory has been described as OTP memory. However, it should be noted that the invention also has utility if used in conjunction with slightly more configurable memory such as ultraviolet erasable NVM or other types of NVM that are somewhat difficult to reprogram in the field. Ultraviolet erasable NVM is used as an example because it is known in the art that reprogramming such NVM usually requires significant effort once a part has been packaged since reprogramming requires the application of ultraviolet light to the memory cells directly. The utility of the present invention will be maintained so long as the redundant memory is not as easily reprogrammed as the directly accessible memory block and the lack of configurability is balanced by a counteracting increase in stability and a decrease in cost. Also, the directly accessible memory does not have to be volatile memory but it must be capable of reliable reprogramming.

Although embodiments of the invention have been discussed primarily with respect to specific embodiments thereof, other variations are possible. Various arbiter circuits and memory access circuits may be used in place of, or in addition to, the circuit configurations presented herein. Functions may be performed by hardware or software, as desired. In general, any circuit diagrams presented are only intended to indicate one possible configuration, and many variations are possible. Those skilled in the art will also appreciate that methods and systems consistent with the present invention are suitable for use in a wide range of applications encompassing any that require reprogrammable memory. While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the spirit and scope of the present invention, which is more particularly set forth in the appended claims. Furthermore, those skilled in the art will appreciate that the foregoing description is by way of example only, and is not intended to limit the invention.

What is claimed is:

1. A multiple write cycle memory for providing field upgrade capability and data robustness to an electronic system, said multiple write cycle memory comprising:
a first block of memory having multiple data locations coupled to an arbiter circuit; and
a second block of memory having multiple cells with individual cell addresses coupled to said arbiter circuit and a memory access circuit;
wherein said data locations each have a corresponding address segment that can be programmed with at least a portion of said cell addresses, a corresponding data segment that can be programmed with data; and
wherein said data locations are programmed by external means and said arbiter can load said data into said multiple cells of said second block of memory in accordance with the value in said address segment.

2. The multiple write cycle memory of claim 1, wherein said second block of memory is volatile memory such as static random access memory (SRAM) and dynamic random access memory (DRAM) and said first block of memory is non-volatile memory (NVM).

3. The multiple write cycle memory of claim 2, wherein said non-volatile memory is less configurable memory comprised of one of electrically programmable read only memory (EPROM) and ultraviolet reprogrammable read only memory.

4. The multiple write cycle memory of claim 1, wherein said portion of said cell address has an address length that is one of the same size and a smaller size than said individual cell addresses as mapped by said arbiter circuit; and
wherein said data is written to one of said multiple cells and a group of several of said multiple cells with a root address equivalent to said portion of said cell address.

5. The multiple write cycle memory of claim 1, wherein said multiple cells have a data capacity that is one of smaller than and equal to the size of said data segments.

6. The multiple write cycle memory of claim 1, wherein said data segment includes a status segment that can be programmed with the status of said data location.

7. The multiple write cycle memory of claim 6, wherein said corresponding status segments include a length code to indicate the length of said data in said corresponding data segment.

8. The multiple write cycle memory of claim 6, each of said corresponding status segments containing a program designation code and an error designation code; wherein said program designation code changes to a different state when said data location is programmed and said error designation code changes to a designating state when said data location contains an error.

9. The multiple write cycle memory of claim 8, wherein said program designation code and said error designation code are externally programmed.

10. The multiple write cycle memory of claim 8, said error designation code comprising an error designation bit that is externally programmed and an error correction code; and
wherein said arbiter will not program or read said data of said corresponding data segment when said error designation code indicates an error.

11. The multiple write cycle memory of claim 10, wherein said error correction code is one of single error correction double error detection (SECDED) and double error correction triple error detection (DECTED).

12. The multiple write cycle memory of claim 10, wherein said error designation bit and said program designation code are stored in a type of memory cell with a higher degree of reliability than the rest of the bits in said data location.

13. A method for providing multiple write cycle capability and data robustness to an electronic system using minimally configurable memory, comprising the steps of:
resetting a stack access apparatus of an arbiter circuit in response to a reset signal;
incrementing said stack access apparatus;
checking the status of a data location in a first block of memory that is currently referenced by said stack access apparatus;
writing to a corresponding cell of a second block of memory with data from a data segment of said data location having a cell address equivalent to an address segment of said data location if said data location has been programmed;
repeating steps from said incrementing until said checking determines said data location has not been programmed;
holding for a program command if said data location has not been programmed;
programming a new address segment and a new data segment into said data location in said first memory block;
returning to said checking of said status.

14. The method of claim 13, wherein said resetting takes place automatically when said reset signal is applied when power is applied to said electronic system.

15. The method of claim 13, wherein consecutive cycles of said programming and returning without incrementing are counted and said repeating steps from said incrementing occurs after a predetermined number of said cycles are counted.

16. The method of claim 13, wherein said programming said data location changes said data segment from a known state and said checking said status of said data location is accomplished by detecting whether or not said data segment is in said known state.

17. The method of claim 13, wherein said writing to said corresponding cell is skipped if said checking said status discerns an error in said data location.

18. The method of claim 13, wherein said writing to said corresponding cell occurs with the use of an error correction code to repair defective bits in said address segment and said data segment.

19. The method of claim 13, wherein said checking said status of said data location includes checking a status segment of said data location.

20. The method of claim 19, wherein said programming said data location includes programming an error indicator into said status segment of said data location if an error is found in said data segment or said address segment.

21. The method of claim 19, wherein said programming said data location includes programming a program indicator into said status segment of said data location.
